(19) United States
(12) Patent Application Publication
(10) Pub. No.: US 2006/0194603 A1
(43) Pub. Date: Aug. 31, 2006

(54) Architecture partitioning of a nonvolatile memory

(76) Inventors: John C. Rudelic, Folsom, CA (US); August A. Camber, Rocklin, CA (US); Robert Hasbun, Placerville, CA (US)

Correspondence Address: INTEL CORPORATION, P.O. BOX 5326, SANTA CLARA, CA, 95056-5326, US

(21) Appl. No.: 11/069,386

(22) Filed: Feb. 28, 2005

(51) Int. Cl. H04M 1/00

(52) U.S. Cl. 455/550.1

(57) ABSTRACT

An architecture for a nonvolatile memory includes an embedded authentication block and an update engine processing device.

The proliferation of mobile devices has evolved into mobile computing platforms, complete with needs for trusted services. Operators, manufacturers and wireless users need confidence in the integrity and security of the wireless network and the wireless device in the distribution of digital data. Mobile devices may have access to sensitive personal data, online payment data and other private information, and therefore, there is a need to facilitate and enable secure transactions to deliver protected and secure services.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating a wireless device that incorporates nonvolatile memory embedded with a cryptography block and an update engine in accordance with the present invention; and

FIG. 2 is block diagram of the nonvolatile memory device illustrated in FIG. 1.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other while “coupled” may further mean that two or more elements are not in direct contact with each other, but yet still co-operate or interact with each other.

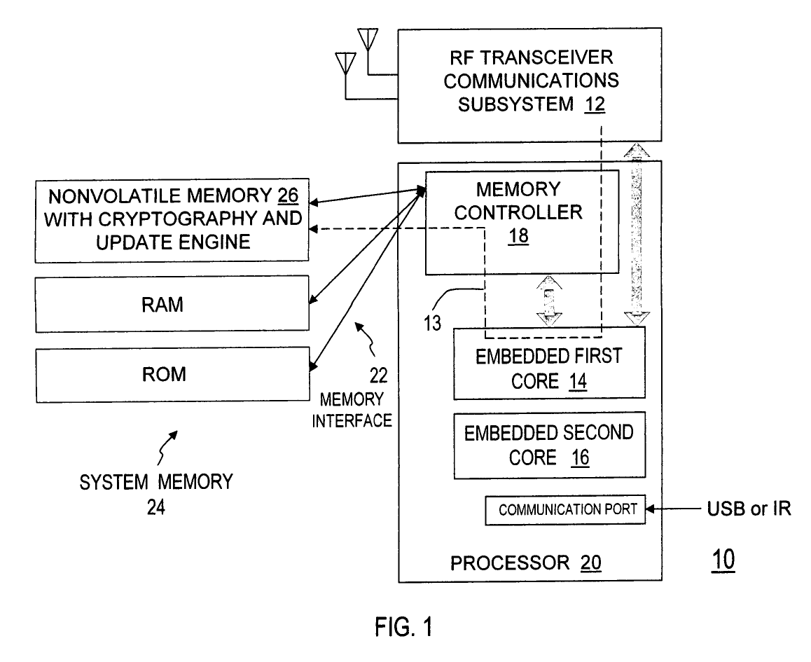

FIG. 1 illustrates features of the present invention that may be incorporated, for example, into a device 10. In the embodiment shown, device 10 is a wireless communications device, but it should be pointed out that the present invention is not limited to wireless applications. In the wireless embodiment a transceiver 12 both receives and transmits a modulated signal from one or more antennas. The analog front end transceiver may be a stand-alone Radio Frequency (RF) integrated analog circuit, or alternatively, be embedded with a processor 20 as a mixed-mode integrated circuit. The received modulated signal may be frequency down-converted, filtered, then converted to a baseband, digital signal.

Processor 20 may include baseband and applications processing functions that utilize one or more processor cores. Processor cores 14 and 16, in general, process functions that fetch instructions, generate decodes, find operands, and perform appropriate actions, then store results. The use of multiple cores may allow one core to be dedicated to handle application specific functions such as, for example, graphics, modem functions, etc. Alternatively, the multiple cores may allow processing workloads to be shared across the cores.

A memory controller 18 controls a memory interface 22 that allows the processor cores and cache memory embedded within processor 20 to exchange data with a system memory 24. System memory 24 may include a combination of memories such as a disc, a Random Access Memory (RAM), a Read Only Memory (ROM) and a nonvolatile memory 26, although neither the type nor variety of memories included in system memory 24 are limitations of the present invention.

Nonvolatile memory 26 may be a memory such as, for example, an ETOX™ Flash NOR Memory, an Electrically Erasable and Programmable Read Only Memory (EEPROM), a Ferroelectric Random Access Memory (FRAM), a Polymer Ferroelectric Random Access Memory (PFRAM), a Magnetic Random Access Memory (MRAM), an Ovonics Unified Memory (OUM), or any other device capable of storing instructions and/or data and retaining that information even with device 10 in a power conservation mode. However, it should be understood that the scope of the present invention is not limited to these examples.

Although processor 20 and nonvolatile memory 26 are shown incorporated into a wireless device 10, the processor and nonvolatile memory may be included together in applications other than wireless applications. Accordingly, embodiments of the present invention may be used in a variety of products, with the claimed subject matter incorporated into desktop computers, laptops, smart phones, MP3 players, cameras, communicators and Personal Digital Assistants (PDAs), medical or biotech equipment, automotive safety and protective equipment, automotive infotainment products, etc. However, it should be understood that the scope of the present invention is not limited to these examples.

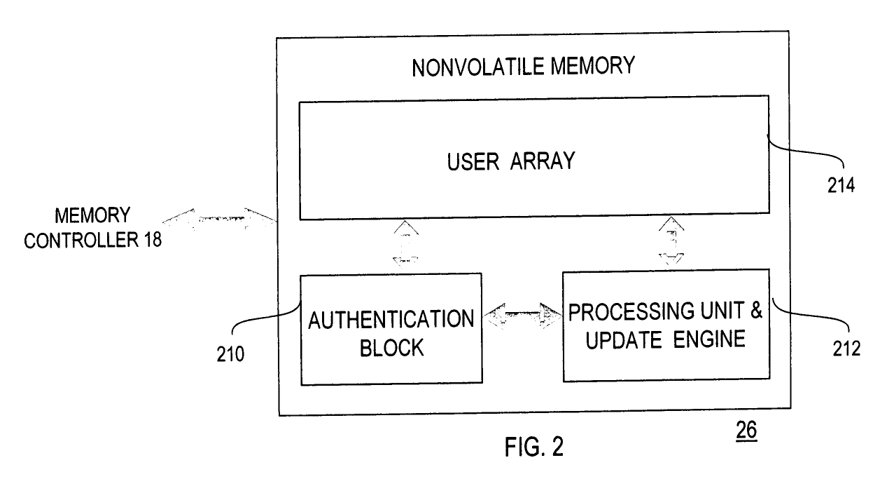

FIG. 2 is block diagram of the nonvolatile memory device 26 illustrated in FIG. 1. Nonvolatile memory device 26 includes an authentication block 210 and an update engine 212 that in one embodiment may be embedded with an arrayed nonvolatile memory 214. Thus, cryptography block 210, update engine 212 and the arrayed nonvolatile memory 214 may be integrated together into a single semiconductor chip. In another embodiment, cryptography block 210, update engine 212 and the arrayed nonvolatile memory 214 may be separately packaged devices that exchange data with processor 20 through memory interface 22. In yet another embodiment, cryptography block 210, update engine 212 and the arrayed nonvolatile memory 214 may collectively be included in a single, multi-chip packaged device.

Note that arrayed nonvolatile memory 214 may be partitioned to include both a secure memory portion and a non-secure memory portion. Alternatively, separate blocks of memories may be designated as secure and non-secure. Update engine 212 may perform bus operations and generate addressing to properly read and program operating code and code updates in secure and non-secure memory locations to prevent un-trusted code from accessing secure resources. Additionally, update engine 212 may perform certain tasks which are described via a command chain that resides in a link list in arrayed nonvolatile memory 214. In accordance with the present invention, direct execution of code from arrayed nonvolatile memory 214 by update engine 212 enhances platform security and allows the use of executable attributes of page tables.

Authentication block 210 may include either a hardware encryption engine or a processor to execute software algorithms, or a combination thereof, and in general address the security concerns for device 10 by performing the necessary mathematical operations in support of encryption, decryption and verification. Thus, authentication block 210 may execute the RSA algorithm, invented in 1978 by Ron Rivest, Adi Shamir and Leonard Adlemen. RSA is a cryptographic algorithm that offers a high level of security for digital data transfers between device 10 and other electronic devices. RSA uses a public key, a private key, and incorporates modular exponentiation mathematics. Modular exponentiation of large integers may be efficiently computed within authentication block 210 by repeated modular multiplications. Pipelining techniques or repetitive multiplication cycles may be used for the massive parallel computations.

Authentication block 210 may further complete hash algorithms such as, for example, the Secure Hash Algorithm (SHA or SHA-1) algorithm. The SHA algorithm takes a given bit stream message and produces a unique 160-bit message digest. The SHA algorithm is specified in the Secure Hash Standard (SHS, FIPS 180), with the SHA-1 algorithm being a revision to SHA that was published in 1994. In accordance with the present invention, authentication block 210 executes instructions and processes data to accommodate applications that include message-digest algorithms, hash functions, public/private keys, digital signatures and authorization certificates.

Update engine 212 includes a processing unit that frees processor 20 from handling certain tasks and operations. Update engine 212 may include address and data registers, data retention storage, counters, decoding logic, state machines and other logic and arithmetic blocks consistent with processing capabilities. Thus, update engine 212 may fetch and execute instructions to perform authentication tasks which with the support of authentication block 210 appropriately address security related issues. By integrating blocks that perform specific functions with update engine 212 and with arrayed nonvolatile memory 214, the performance of device 10 may be improved and significant value may be provided to users and carriers.

An instruction received by transceiver 12 may be identified by processor 20 and passed to update engine 26 for execution (see the path identified by the dotted line 13 in FIG. 1) without further actions by processor 20. In this embodiment, instructions received over-the-air by transceiver 12 that relate to authentication tasks are routed to update engine 26. Update engine 26 executes the instruction and utilizes authentication block 210 and arrayed nonvolatile memory 214 to perform tasks such as, for example, encryption, decryption, authentication, verification of digitally signed messages and attachments including text, spreadsheets, word processing documents, voice and video files, and storing of data, all without burdening processor 20.

In another embodiment, update engine 212 manages updates and patches to software code stored by arrayed nonvolatile memory 214. Transceiver 12 receives over-the-air code that is passed through memory interface 22 to arrayed nonvolatile memory 214. Thus, without intervention by processor 20, software received by update engine 212 may be verified using authentication block 210 to resolve security issues, then accepted and stored in arrayed nonvolatile memory 214. By properly managing updates and patches to the existing code, device 10 may prevent the loss, misuse and alteration of the information under the control of device 10. Once the code is accepted as being authorized, rights may be granted to transactions based on a secure/non-secure status. In this embodiment, the integration of an update engine 212 to manage data transfers and an authentication block 210 to resolve security issues frees processor 20 to handle other operations.

In one embodiment, updates and patches to software code stored by arrayed nonvolatile memory 214 may apply to the Basic Input/Output System (BIOS) code. An update BIOS command may be received by transceiver 12 and passed through memory interface 22 to the processing unit and update engine 212. The updated BIOS software received by update engine 212 may be verified using authentication block 210 to resolve security issues. When the BIOS code security issues are resolved, then the updated code may be received in over-the-air transmissions, accepted and stored in arrayed nonvolatile memory 214.

By utilizing the processing unit and update engine 212 along with the authentication block 210 within nonvolatile memory 26, the present invention may securely authenticate BIOS patches and code updates to handsets. Carriers may realize significant cost savings in providing over-the-air BIOS updates that utilize the closed system provided by processing unit and update engine 212, authentication block 210 and arrayed nonvolatile memory 214. The closed system inhibits attacks on stored code by preventing code from being viewed, corrupted or interrupted. Note that updates to BIOS code may be made invisible to the host processor, i.e., processor 20 (see FIG. 1). In other words, processor 20 may be isolated from the closed system during the authentication process and during the code update process. The host processor may be prevented from interrupting nonvolatile memory 26 to further deny malicious attacks during authentication and BIOS code updates.

Specific applications may be requested, downloaded and run by device 10. The application download needs to be authenticated before acceptance is granted and permission to execute the application is granted. Again, the closed system within nonvolatile memory 26 that includes update engine 212, authentication block 210 and arrayed nonvolatile memory 214, may be used to verify and provide billing information associated with the application request, verify the authenticity of the application itself, and inhibit attacks on the received application code, etc. Again, processor 20 may be isolated from the closed system during the application authentication and acceptance process, and the billing process. Host processor 20 may be signaled with permission to execute the received application.

In another embodiment, data may be downloaded from an electronic device such as, for example, a Personal Computer (PC) to wireless device 10 via a Universal Serial Bus (USB). USB offers benefits such as low cost, expandability, auto-configuration and hot-plugging. USB also provides power to the bus, enabling many peripherals to operate without the added need for an AC power adapter. USB may operate at 1.5 Megabits per second (Mbps) and/or 12 Mbps. As before, some instructions received by device 10 may be identified by processor 20 and passed to update engine 26 in nonvolatile memory 26 for execution without further actions by processor 20. For example, instructions that relate to authentication tasks are routed to update engine 26. Update engine 26 executes the instruction and utilizes authentication block 210 and arrayed nonvolatile memory 214. Update engine 26 performs encryption, decryption, authentication and verification tasks, all without burdening processor 20. In an alternate embodiment, infrared techniques using infrared Light Emitting Diodes (LEDs) may be used to transfer data from an electronic device to device 10.

By now it should be apparent that embodiments of the present invention provide an architectural approach for performing authenticated updates in a nonvolatile memory. Further, by incorporating the described architecture the logic and processing power assigned to perform authentication and/or memory modification tasks related to memory updates resides within the non-volatile memory. Performing selected tasks within the nonvolatile memory creates a closed system that cannot be viewed, corrupted, or interrupted by malicious or unreliable software.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A wireless device, comprising:
a transceiver coupled to an antenna; and
a nonvolatile memory having an authentication block, wherein the nonvolatile memory receives information from the antenna and uses the authentication block to authenticate the information before storage in the nonvolatile memory.

2. The wireless device of claim 1 further comprising a processor having first and second processor cores that is coupled to the transceiver to receive and transfer the information to the nonvolatile memory.

3. The wireless device of claim 2 wherein the nonvolatile memory authorizes the information without using the first and second processor cores.

4. The wireless device of claim 1 wherein the nonvolatile memory further includes an update engine to receive the information and execute an instruction to the authentication block.

5. The wireless device of claim 1 wherein the update engine and the authentication block authorize software that is received over-the-air by the antenna for storage by the nonvolatile memory.

6. The wireless device of claim 5 wherein the software that is received over-the-air is BIOS code that the update engine determines is secure code to be stored in a secure portion of the nonvolatile memory.

7. A nonvolatile memory comprising:
an update engine to receive code;
an authentication block; and
a flash memory integrated with the update engine and the authentication block to perform authentication of code.

8. The nonvolatile memory of claim 7 wherein the update engine and the authentication block authorize the code before storage in the flash memory.

9. The nonvolatile memory of claim 7 wherein the update engine locks the flash memory

10. The nonvolatile memory of claim 7 wherein the update engine controls application of changes in the code stored in the flash memory.

11. A nonvolatile memory comprising:
an update engine;
an authentication block; and
a flash memory embedded in an integrated circuit with the update engine and the authentication block, wherein the update engine receives the code and uses the authentication block to determine whether to lock a block of the flash memory.

12. The nonvolatile memory of claim 11 wherein the update engine receives updated Basic Input/Output System (BIOS) code that is authenticated by the authentication block.

13. The nonvolatile memory of claim 12 wherein the update engine locks a portion of the flash memory after storing the BIOS without the nonvolatile memory receiving an external lock instruction.

14. A device, comprising:
a nonvolatile memory having an authentication block, wherein the nonvolatile memory receives information from another device and uses the authentication block to authenticate the information before storage in the nonvolatile memory.

15. The device of claim 14 wherein information from another device is transferred through a Universal Serial Bus (USB) to the nonvolatile memory where the authentication block provides authentication of the information.

16. The device of claim 14 wherein information from another device is transferred through an infrared connection to the nonvolatile memory where the authentication block provides authentication of the information.

17. A device, comprising:
a processor to execute instructions; and
a nonvolatile memory integrated separately from the processor, wherein the nonvolatile memory has an authentication block to authenticate applications downloaded to the device.

18. The device of claim 17 wherein the processor is prevented from receiving an interrupt when the authentication block authenticates the applications.

19. The device of claim 17 where billing transactions associated with the application are authenticated within the nonvolatile memory and without intervention by the processor.

20. The device of claim 17 wherein updates to code stored in the nonvolatile memory are received, authenticated and the updated code stored in the nonvolatile memory without intervention by the processor.
